(19) United States
(12) Patent Application Publication
(10) Pub. No.: US 2024/0228815 A1
(43) Pub. Date: Jul. 11, 2024

(54) SEALING COATING FOR WIRE AND CABLE APPLICATION

(71) Applicant: Arkema Inc., King of Prussia, PA (US)

(72) Inventors: Yujie LIU, King of Prussia, PA (US); Skip M. SPARKS, King of Prussia, PA (US); James J. HENRY, King of Prussia, PA (US)

(21) Appl. No.: 18/285,866

(22) PCT Filed: Apr. 7, 2022
(86) PCT No.: PCT/US2022/023763

§ 371 Date: Oct. 6, 2023

Related U.S. Application Data
(60) Provisional application No. 63/176,989, filed on Apr. 20, 2021.

(51) Int. Cl. C09D 127/16; C08F 214/22; C09D 7/20; H01B 3/44; H01B 13/00; H01B 13/16; H02G 15/08

(52) U.S. Cl. CPC C09D 127/16; C08F 214/22; C09D 7/20; H01B 3/445; H01B 13/0016; H01B 13/165; C08F 2800/20; H02G 15/08

(57) ABSTRACT

A connecting composition and a scaling coating for wire or cable insulation is disclosed. The connecting composition comprising a PVDF copolymer and a solvent. The solvent comprises cyclic ketone, wherein the weight percent of PVDF copolymer is from 20 to 40 wt. %, preferably 20 to 35 wt. % based on the total weight of PVDF copolymer and solvent. The PVDF copolymer comprises one or more comonomers and at least 75 wt. % vinylidene fluoride units, preferable at least 80% vinylidene fluoride units and has a melt viscosity of 2 to 12, preferably 4 and 10 kPoise at 230° C. and 100 s−1.

### FIELD OF THE INVENTION

A protective sealing connecting coating for wire or cable joints is disclosed.

### BACKGROUND OF RELATED ART

When a splice or connection is needed to combine two or more cables or wires together (to form a joint), the protective insulation (primary insulation) around the core needs to be removed thus exposing the core (“open region”), and if not repaired, the open joint (or open region) can be a potential failure point due to environmental exposure. The insulation ends adjacent to the joint can also allow fluids to wick between the insulation and wire or cable core and cause corrosion leading to premature wire or cable failure.

The joint can be formed by cutting two or more wire or cable ends, stripping back the primary insulation, and then joining the exposed wire or cable ends, or, a portion of the primary insulation can be removed from one wire or cable exposing the wire or cable core, and then a second wire or cable can be attached to the exposed core to form a joint. Independent of how or why a joint is formed, the joint no longer has the protection of the primary insulation continuously covering each wire or cable.

There exists many means of reapplying an insulative material to cover and protect a wire or cable joint. One common means is the application of a heat shrink tubing around the joint. The heat shrink tubing is applied by inserting the joint through the heat shrink tubing, and then shrinking the tube by applying heat directly on the heat shrink tubing. The heat shrink tubing begins to shrink as the temperature rises above the melting point of the heat shrink tubing. The heat shrink tubing size reduces and contacts the joint to provide an insulative covering. Adhesives and other mastic sealant can be used at the interphase between the heat shrink tubing and the primary insulation to create a seal to prevent fluid penetration. An example of this technology can be found in U.S. Pat. No. 3,297,819A which describes a heat shrink tube (referred to as a “heat unstable covering”) that can have a fusible material forming a highly efficient bond. Other common methods of protecting the exposed joint include but not limited to electrical tapes, sealants, and any combinations of these methods.

Industrial cables used in more severe environments often require fluoropolymers to be used as the primary insulation over the cable or wire core. Fluoropolymers in general are known to be chemically resistant and provide high temperature resistance. Fluoropolymer insulation, whether a primary insulation, a protective barrier layer, or as a jacket, allows such cables or wires to be used in environments that traditional cables or wires using PVC or olefin primary insulation cannot survive. Such environments include those exposed to chemicals, elevated temperatures, radiation, and extended outdoor exposure. Cable or wire produced using a fluoropolymer primary insulation, are generally used in a difficult and/or harsh environment.

Cables or wires produced using fluoropolymer primary insulation, depending on design and use, may require the need for a joint to splice two or more wires or cables together, or to attach one or more wires along the length of a different wire or cable. In order to form a joint on a cable or wire comprised of fluoropolymer primary insulation, the fluoropolymer primary insulation needs to be removed at the location where the joint is required. Once the protective fluoropolymer insulation is broken or removed, the wire is now exposed to conditions from the environment that could lead to cable or wire core damage. In order to properly repair the joint, the protective fluoropolymer insulation needs to be a continuous layer to prevent liquids and harsh chemicals from penetrating the insulation and attacking the cable or wire core. In cases where the environment is considered extreme, commonly used methods of protecting the joint such as heat shrink tubing, sealants and tapes do not provide a continuous fluoropolymer insulation layer, and may not provide necessary protection resulting in cable or wire core damage. To withstand harsh environmental conditions, the insulation layer needs to be a continuous impenetrable fluoropolymer covering.

U.S. Pat. No. 8,502,074 B2, describes a means of protecting the joint by introducing a sealing device by molding in situ about the joint comprised of either PVDF or polyethylene. If the connection is not waterproof, there is a high risk of connection failure. To that end, various approaches have been taken to seal the joint and isolate it from the ambient surroundings.

There exists a need to fix a break in a wire or cable fluoropolymer insulation that results in continuous fluoropolymer protective layer on cables or wires and a barrier seal against water or other fluids.

### SUMMARY OF THE INVENTION

Disclosed is a composition, a “connecting composition” for providing a “sealing connecting coating”, also referred to as a “sealing coating” for wire or cable. Disclosed is a method of providing a connecting coating on a wire or cable joint having a fluoropolymer insulation. Disclosed is a wire or cable joint having a sealing connecting coating. Disclosed is a method of repairing damaged wire or cables providing a sealing connecting coating to the damaged region. The inventive composition provides a new and novel way to re-connect a fluoropolymer insulation on a wire or cable that has been broken or partially opened to the core, in a continuous manner creating a barrier seal such that fluids (liquid or gas) cannot penetrate and contact the core. This can be done by applying the inventive composition to the wire or cable to cover the break or opened area in the fluoropolymer insulation and then drying the inventive composition to create the sealing coating on the wire or cable. Applying the inventive composition to cover the break in the fluoropolymer insulation and drying it results in a continuous fluoropolymer protective layer comprising the sealing coating on the wire or cable.

To create a barrier seal, the inventive composition adheres to the fluoropolymer insulation in a manner that produces a barrier to fluids as well as gases. Preferably, the inventive composition is used with a fluoropolymer insulation comprising a PVDF resin or PVDF copolymer. Preferably, the fluoropolymer insulation is primary insulation. The inventive composition is able to adhere to the fluoropolymer insulation and to penetrate under the fluoropolymer insulation and between conductors to further secure and lock in the composition once dried, thus further improving the barrier seal, preventing fluid from contacting the core.

One such cable that can use this inventive composition is referred to as a Cathodic Protection Cable. Cathodic Protection Cables used in severe environments, such as when in direct contact with water or brine, normally comprise a fluoropolymer insulation layer under the polyolefin “secondary” insulation layer. The fluoropolymer insulation layer in this case would be considered the primary insulation and the olefin layer a protective jacket.

When a joint is needed on a Cathodic Protection Cable having a fluoropolymer insulation, the fluoropolymer insulation is broken in order to make the connection. The inventive composition described herein can be used on a Cathodic Protection Cable to repair the break and create a continuous fluoropolymer barrier insulation covering. The inventive composition can also be used in a similar fashion for any cable comprising a fluoropolymer insulation layer. The preferred embodiment is to apply the inventive composition to wires or cables containing a fluoropolymer insulation, and more specifically, where the fluoropolymer insulation is comprised of PVDF primary insulation. The inventive composition can be used alone, or in combination with any other common method of covering and protecting an exposed joint or break in the fluoropolymer insulation. As an example, a heat shrink tubing having an adhesive or electrical tape can be used over the inventive composition to provide further protection.

### Aspects of the Inventions

Aspect 1: A connecting composition comprising a PVDF copolymer and a solvent wherein the solvent comprises cyclic ketone, wherein the weight percent of PVDF copolymer is from 20 to 40 wt. %, preferably 20 to 35 wt. % based on the total weight of PVDF copolymer and solvent, and wherein the PVDF copolymer comprising at least 75 wt. % vinylidene fluoride units, preferable at least 80% vinylidene fluoride units and has a melt viscosity of 2 to 12, preferably 4 and 10 kPoise at 230° C. and 100 s−1.

Aspect 2: The composition of aspect 1, wherein the PVDF copolymer comprises from 2 to 25 wt. % co-monomer.

Aspect 3: The composition of aspect 1 or 2, wherein the co-monomer is selected from the group consisting of vinyl fluoride; trifluoroethylene (VF3); chlorotrifluoroethylene (CTFE); 1,2-difluoroethylene; tetrafluoroethylene (TFE); hexafluoropropylene (HFP); 2,3,3,3-tetrafluoropropylene; 1,3,3,3-tetrafluoropropylene; 3,3,3-trifluoropropylene; perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD), preferably HFP, 2,3,3,3-tetrafluoropropylene, 3,3,3-trifluoropropylene, TFE combinations thereof.

Aspect 4: The composition of any one of aspects 1 to 3, wherein the co-monomer comprises HFP.

Aspect 5: The composition of any one of aspects 1 to 4, wherein the cyclic ketone comprises cyclopentanone.

Aspect 6: The composition of any one of aspects 1 to 5, wherein the solvent further comprises a co solvent.

Aspect 7: The composition of one of aspects 1 to 6, wherein the co-solvent comprises acetone or a C1 to C6 alcohol.

Aspect 8: The composition of any one of aspects 1 to 7, wherein the cyclic ketone comprises greater than 20 wt. %, preferably greater than 30 wt. % of the total solvent.

Aspect 9: The composition of any one of aspects 1 to 8, wherein the molecular weight of the PVDF copolymer is from 150 to 400 kg/mol, preferably from 150 to 300 kg/mol, and more preferably from 180 to 220 kg/mol, as determined by GPC with PMMA acrylic standard.

Aspect 10: A method of coating a cable or wire joint, the method comprising providing the connecting composition of any one of aspects 1 to 9, providing a joint connecting a first cable or wire or sensor to a second cable or wire wherein at least one of the first cable or wire or sensor or the second cable or wire has an fluoropolymer insulation thereon except at an open region where the first cable or wire or sensor is connected to the second cable or wire, applying the connecting composition about the joint to completely cover the joint and bond to portions of the insulating covering contiguous with the open region thereby providing a continuous fluoropolymer insulating covering the joint.

Aspect 11: A method of repairing a break in wire or cable fluoropolymer insulation comprising providing the connecting composition of any one of aspects 1 to 9, providing a wire or cable having a break in the fluoropolymer insulation of the wire or cable, applying the connecting composition over the break in the insulation, drying the applied connecting composition to create a continuous fluoropolymer insulating covering on the break.

Aspect 12: The method of aspect 10 or 11, wherein the connecting composition is applied by spraying or painting the connecting composition onto the cable or wire.

Aspect 13: The method of any one of aspects 10 to 12, wherein the connecting composition is applied at ambient temperature.

Aspect 14: The method of any one of aspects 10 or 13, wherein the connecting composition is dried at a temperature of from 20° C. up to a temperature of 160° C., preferably from 40 to 155° C.

Aspect 15: The method of any one of aspects 10 or 14, wherein the heat is applied locally to the connecting composition covering the open region or insulation break.

Aspect 16: The method of any one of aspects 10 or 15, wherein the method further comprising applying more than one layer of the connecting composition.

Aspect 17: The method of any one of aspects 10 or 16, wherein the wherein the fluoropolymer insulation comprises a homopolymer or copolymer having a melt viscosity of from 4 to 40 kP measured at 100 sec⁻¹ at 230° C.

Aspect 18: The method of any one of aspects 10 to 17, wherein the wherein the fluoropolymer insulation comprises a polyvinylidene fluoride homopolymer or copolymer.

Aspect 19: A joint connecting a first cable or wire or sensor to a second cable or wire, wherein at least one of the cables or wires comprises a fluoropolymer insulation, wherein said joint additionally comprises a sealing coating covering the joint and bonded to portions of the fluoropolymer insulation contiguous with the joint to thereby insulate the joint, wherein the sealing coating comprises a PVDF copolymer having a melt viscosity in the range of 2 to 12 kP, preferably 4 to 10 kPoise at 230° C. and 100 s⁻¹.

Aspect 20: The joint of aspect 19, wherein the PVDF copolymer comprises from 2 to 25 wt. % co-monomer.

Aspect 21: The composition of aspect 19 or 20, wherein the co-monomer is selected from the group consisting of vinyl fluoride; trifluoroethylene (VF3); chlorotrifluoroethylene (CTFE); 1,2-difluoroethylene; tetrafluoroethylene (TFE); hexafluoropropylene (HFP); 2,3,3,3-tetrafluoropropylene; 1,3,3,3-tetrafluoropropylene; 3,3,3-trifluoropropylene; perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD), preferably HFP, 2,3,3,3-tetrafluoropropylene, 3,3,3-trifluoropropylene, TFE combinations thereof.

Aspect 22: The composition of aspect 19 or 20, wherein the co-monomer comprises HFP.

Aspect 23: The joint of any one of aspects 19 to 22, wherein the fluoropolymer insulation is a PVDF homopolymer or copolymer.

Aspect 24: The joint of any one of aspects 19 to 23, wherein the sealing connecting composition adheres to the fluoropolymer insulation and forms a water proof seal.

Aspect 25: The joint of any one of aspects 19 to 24, wherein one layer of the sealing coating is from 60 to 200 micron thick.

### DETAILED DESCRIPTION OF THE INVENTION

The references cited in this application are incorporated herein by reference.

Percentages, as used herein are weight percentages (wt. %), unless noted otherwise, and molecular weights are weight average molecular weights (Mw), unless otherwise stated. Molecular weight is measured by gel permeation chromatography (GPC) using PMMA (Polymethylmethacrylate) standards. Melt viscosity (MV) is measured at 230° C. at 100 sec⁻¹.

“Copolymer” is used to mean a polymer having two or more different monomer units. “Polymer” is used to mean both homopolymer and copolymers. “PVDF” means “polyvinylidene fluoride”. For example, as used herein, “PVDF” and “polyvinylidene fluoride” are used to connote both the homopolymer and copolymers, unless specifically noted otherwise. The polymers may be homogeneous, heterogeneous, or random, and may have a gradient distribution of co-monomer units.

A “joint” is described as the point along a wire or cable where two or more wires are jointed. A joint can be a wire connection such as a “splice” where two or more wire or cable lengths are connected. To create a joint, the protective insulating covering is removed exposing the core so that the core of two different wires or cables can be connected.

A wire or cable “primary insulation” is the polymer layer that is in direct contact with the wire or cable core. A “jacket” or “secondary insulation” is an insulation layer that is applied over one or more wires or cables already containing primary insulation. The term “insulating covering” is used herein more generally to describe any insulation over a central core and can include primary insulation, secondary insulation and other covering layers. The “core” is what resides in the center of the cable. The core is often one or more conductors. A “sealing connecting coating”, also referred to as a “sealing coating”, is the coating created by the inventive composition. Fluoropolymer insulation is the insulation existing on the wire or cable prior to being damaged or opened to create a joint. Fluoropolymer barrier insulation covering comprises the sealing coating and the fluoropolymer insulation.

The invention relates to a composition comprising a PVDF copolymer in a solvent. The invention relates to a sealing coating created from the composition, used in wire and cable applications. The invention also pertains to a method of making a sealing coating on a wire or cable by applying the inventive composition to a wire or cable at a joint or point where the insulating covering is discontinuous (a break in the insulation). The invention also concerns a wire or cable comprising the sealing coating.

### Connecting Composition

The invention provides a connecting composition for sealing a joint or other break in a wire or cable insulation. The connecting composition used in the invention comprises a PVDF copolymer and a solvent wherein the solvent comprises cyclic ketone. The weight percent of PVDF is from 20 to 40 wt. %, preferably 22 to 35 wt. %, more preferably 25 to 35 wt. % based on the total weight of PVDF copolymer and solvent in the connecting composition. Solids content below 20 wt. % yields viscosity too low such that not enough material is applied. Solids content above 40 wt. % content yields viscosity too high such that during drying did not form a homogenous coating. The PVDF copolymer is preferably a VDF/HFP copolymer.

Other additives can be included in the connecting composition, such as filler, fibers, pigments, viscosity modifiers.

PVDF copolymers in the inventive composition and sealing connecting coating.

The term PVDF copolymers denotes copolymers of vinylidene fluoride (VDF) containing one or more other fluorinated co-monomers. The PVDF copolymers of the invention are those in which vinylidene fluoride units comprise greater than 60 wt. % of all the monomer units in the polymer, more preferably comprise greater than 70 wt. % of the units, and most preferably comprise greater than 75 wt. % or greater of the total weight of the units. The fluorinated co-monomer(s) comprises less than 40 wt. %, preferably less than 30 wt. % more preferably less than 25 wt. % fluorinated co-monomer. Preferably, the fluorinated co-monomer(s) are present in the polymer from 25 to 2 wt. %, fluorinated co-monomer(s).

Fluorinated co-monomers are chosen from compounds containing a vinyl group capable of opening in order to be polymerized and that contains, directly attached to this vinyl group, at least one fluorine atom, at least one fluoroalkyl group or at least one fluoroalkoxy group except VDF as it is already present in the PVDF copolymer. Examples of fluorinated co-monomers include, but are not limited to vinyl fluoride; trifluoroethylene (VF3); chlorotrifluoroethylene (CTFE); 1,2-difluoroethylene; tetrafluoroethylene (TFE); hexafluoropropylene (HFP); 2,3,3,3-tetrafluoropropylene; 1,3,3,3-tetrafluoropropylene; 3,3,3-trifluoropropylene; perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD). Preferred PVDF copolymers include copolymers of copolymers of VDF and HFP, copolymers of VDF and 2,3,3,3-tetrafluoropropylene, copolymers of VDF and 3,3,3-trifluoropropylene, terpolymers of VDF, HFP, and TFE (“THV”).

Preferably, the PVDF copolymer used as the connecting composition and the sealing coating comprises a copolymer of VDF and HFP. In one embodiment, the PVDF copolymer comprises at least 70 wt % VDF units and 30 wt % or less HFP units, preferably 75 wt % VDF units and 25 wt % or less HFP units, preferably from 2 to 25 wt. %, hexafluoropropene (HFP) units.

The PVDF copolymer has a melt viscosity of greater than 2.0 kilopoise (kP), preferably greater than 4 kP, preferably greater than 6 kP and up to 12 kP or up to 10 kP according to ASTM method D-3835 measured at 230° C. and 100 sec⁻¹. A preferred range is from 4 kP to 10 kP. PVDF copolymer preferably has a melting point of between 100° C. and 150° C., preferably 110° C. to 130° C.

In some embodiments, the PVDF copolymer for use in the sealing coating of the invention is a copolymer and has a weight average molecular weight of from 150 to 400, preferably 150 to 350, more preferably 150 to 310 kg/mol, more preferably 150 to 250 kg/mol as determined by gel permeation chromatography (GPC) with PMMA standard.

The PVDF copolymer used in the invention in the sealing coating is generally prepared by means known in the art, using aqueous free-radical emulsion polymerization—although suspension, solution and supercritical CO₂ polymerization processes may also be used.

In a general emulsion polymerization process, a reactor is charged with deionized water, water-soluble surfactant capable of emulsifying the reactant mass during polymerization and optional paraffin wax antifoulant. The mixture is stirred and deoxygenated. Optionally, a predetermined amount of chain transfer agent, CTA, is then introduced into the reactor, the reactor temperature raised to the desired level and vinylidene fluoride and one or more co-monomers are fed into the reactor. Once the initial charge of vinylidene fluoride and co-monomers is introduced and the pressure in the reactor has reached the desired level, an initiator emulsion or solution is introduced to start the polymerization reaction. The temperature of the reaction can vary depending on the characteristics of the initiator used and one of skill in the art will know how to do so. Typically, the temperature will be from about 30° C. to 150° C., preferably from about 60° to 120° C. Once the desired amount of polymer has been reached in the reactor, the monomer feed will be stopped, but initiator feed is optionally continued to consume residual monomer. Residual gases (containing unreacted monomers) are vented and the latex recovered from the reactor.

The surfactant used in the polymerization can be any surfactant known in the art to be useful in PVDF emulsion polymerization, including perfluorinated, partially fluorinated, and non-fluorinated surfactants. Preferably, the PVDF copolymer emulsion of the invention is fluorosurfactant free, with no fluorosurfactants being used in any part of the polymerization. Non-fluorinated surfactants useful in the PVDF polymerization could be both ionic and non-ionic in nature including, but are not limited to, 3-allyloxy-2-hydroxy-1-propane sulfonic acid salt, polyvinylphosphonic acid, polyacrylic acids, polyvinyl sulfonic acid, and salts thereof, polyethylene glycol and/or polypropylene glycol and the block copolymers thereof, alkyl phosphonates and siloxane-based surfactants.

The PVDF copolymerization results in a latex generally having a solids level of 10 to 60 percent by weight, preferably 10 to 50 wt. %, and having a latex weight average particle size of less than 500 nm, preferably less than 400 nm, and more preferably less than 300 nm. The discrete weight (also referred to as volume) average particle size is generally at least 20 nm and preferably at least 50 nm. When the latex is dried, the discrete particles of the latex coagulate to form a larger size powder particle.

A minor amount (preferably less than 10 wt. %, more preferably less than 5 wt. %) of one or more other water-miscible solvents, such as ethylene glycol, may be mixed into the PVDF latex to improve freeze-thaw stability.

A suspension polymerization generally results in a larger particle size then produced in emulsion polymerization.

The PVDF copolymer, whether made by latex or suspension, is dried to a powder by means known in the art, such as, but not limited to, spray drying, freeze-drying, coagulating, and drum drying. The dried PVDF copolymer powder preferably has an average particle size of from 0.5 to 200 microns, preferably from 1 to 100 microns, more preferably from 2 to 50 microns.

Especially useful VDF/HFP copolymers include, but are not limited to KYNAR FLEX® PVDF resins from Arkema Inc. (King of Prussia, PA, USA).

The PVDF copolymer is not cross-linked and does not contain cross-linking moieties.

### Solvents

Cyclic ketones or cyclic ketone with a low boiling point co-solvent are preferred solvents for the present invention. Low boiling point means below 80° C. Example cyclic ketones include, but are not limited to, cyclopropanone, cyclohexanone, cyclobutanone, cyclopentanone. A general formula for some cyclic ketone is (CH₂)ₙCO where n varies from 2 to 18. A preferred cyclic ketone is cyclopentanone. The solvent system used in the invention can comprise cosolvents. Co-solvents can be solvents typically used for PVDF which have low boiling points. Examples of co-solvents include but are not limited to acetone, ketones (such as methyl ethyl ketone (MEK), methyl propyl ketone (MPK)), C1 to C6 alcohols such as methanol or ethanol; and combinations thereof. For example, cyclopentanone can be used with acetone as the solvent system.

Preferably, to prepare the connecting composition, the PVDF copolymer and the solvent are combined and then optionally held at an elevated temperature, preferably of from 40 to 60° C., to accelerate the dissolution of the polymer in the solvent.

In a preferred composition, the solvent is cyclopentanone and the PVDF is a VDF/HFP copolymer comprising from 2 to 25 wt. % HFP, and melt viscosity of greater than 2, preferably greater than 4 kp and up to 12 Kp, preferably up to 10 according to ASTM method D-3835 measured at 230° C. and 100 sec⁻¹. A preferred range is from 4 kP to 10 kP.

### Use of the Composition on Wire or Cable.

The inventive composition is used on any wire or cable having a fluoropolymer insulation where the fluoropolymer insulation exhibits a break in the insulation. The break in insulation can be a result of the formation of a joint or the fluoropolymer insulation could be damaged/broken during manufacturing, installation or in service.

The connecting composition and the resultant sealing coating is most useful in PVDF insulated covered wires and cables having metal conductors in the form of a multistrand conductor, but can also be used when the metal conductors are in other forms such as a solid conductor.

When using the connecting composition on a joint, one of the wires or cables within the joint will have a fluoropolymer insulation, preferably, the fluoropolymer insulation is a primary insulation comprising PVDF.

A method is provided for insulating and sealing a joint comprised of two or more wires or cables or is used for sealing a break in the fluoropolymer insulation of a wire or cable. The method comprising applying a connecting composition about the joint or break in fluoropolymer insulation and drying the applied connecting composition to create a sealing coating. The invention provides a method for insulating and sealing a joint connecting a first cable or wire or sensor to a second cable or wire. At least one of the cable or wires being connected will have a primary insulation thereon except at an open region where the first cable or wire or sensor is connected to the second cable or wire to form a joint. The open region is the region on a sensor, probe, cable or wire where the primary insulation has been removed to expose the wire or cable. The method comprises applying a connecting composition in situ about the joint to completely cover the joint and in contact with the fluoropolymer insulation contiguous with the open region and bond to portions of the fluoropolymer insulation, preferably the primary insulation, contiguous with the open region to thereby insulate the joint and prevent the ingress of fluids, such as water or other materials, into the joint.

A method of repairing a break in a wire of cable insulation is provided. The connecting composition is applied to completely cover the joint or break in the fluoropolymer insulation and then dried creating the sealing coating on the cable or wire covering the joint or break. The connecting composition bonds to the fluoropolymer insulation contiguous with the open region, creating a continuous fluoropolymer insulating covering comprising the sealing coating. The sealing coating insulates the wire or cable and can prevent the ingress of fluids such as water or other materials into the wire or cable. The connecting composition is applied in a single coat or in multiple coats to achieve a target thickness.

The connecting composition can also work if there is another material between the fluoropolymer insulation and the core; for example a dual walled insulation comprised of an inner olefin layer and an outer fluoropolymer layer.

The connecting composition can be field applied at room temperature or higher. The temperature used to dry the connecting composition after being applied to the wire or cable is less than 175° C., preferably less than 160° C., and most preferably in the range of from 30° C. to 160° C., more preferably from 40° C. to 160° C. In some embodiments, the preferred temperature range is from 100° C. to 155° C.

The sealing coating can be a single layer or multiple layers applied on top of each other. The thickness of a dried single layer sealing coating is between 20 microns to 200 microns.

Other methods of improving the durability of the sealing coating can be introduced and include, but are not limited to, extruding or molding another polymer layer over the sealing coating, heat shrink tubing or tape or mastics or molding a sealing layer using a melt processable polymer or any combination of these or other used sealing methods.

Preferably, the fluoropolymer insulation will be a melt processable fluoropolymer with a melt viscosity from 4 to 40 kP, preferably 10 to 40 kP measured at 100 sec⁻¹ at 230° C. and a melting point of between 120 and 173° C., preferably between 135 to 171° C., more preferably between 140° C. to 169° C. The fluoropolymer insulation is preferably a PVDF homopolymer or copolymer comprised of at least 80 wt. % VDF monomeric units, preferably between 80 and 98 wt. % VDF. The co-monomer is preferably HFP. Example of such polymers included Kynar®460 PVDF, Kynar Flex® 2850 PVDF series, Kynar Flex® 3120 PVDF series, Kynar® 700 PVDF series all available from Arkema Inc.

The invention provides an insulated joint connecting a first cable or wire or sensor to a second cable or wire comprising a sealing coating. At least one of the cable or wires being connected will have a primary insulation thereon except at an open region where the first cable or wire or sensor is connected to the second cable or wire to form a joint. The joint additionally comprises a dried, sealing coating applied about the joint to completely cover the joint and bonded to portions of the primary insulation contiguous with the open region to insulate the joint and prevent the ingress of water or other materials into the joint. The first cable or wire or sensor may also have an insulating cover except at the point of connection to the second cable or wire.

The present invention can provide a continuous fluoropolymer covered conductive cable having joints (second wire or cable or sensors) for use underwater. A splice or wire connection is used to combine two or more wires or cables together to form a joint. The joint can be formed by cutting two wire or cable ends, stripping back the primary insulation, and then joining the two exposed wire or cable ends, or, a portion of the primary insulation can be removed from a first wire or cable to expose the wire or cable core, and then a second wire or cable can be attached to the exposed core of the first wire or cable to form a joint. Sensors, probes or other wires can be attached to a second cable or wire at the open region where the primary insulation has been removed to expose the wire or cable core.

In some aspects of the invention, the wire or cable is an electrically conductive wire or cable.

The sealing coating has good adhesion to the fluoropolymer insulation and also to the wire or cable comprising the joint thereby creating a waterproof seal around the joint or connection that has been coated with the composition of the invention.

### Examples

i-PVDF is a typical insulation material used on cables having a melt viscosity of between 10 kP to 40 kP measured at 100 sec⁻¹ at 230° C.

Initial screening: Apply the sealing coating composition to an i-PVDF extruded dog-bone tensile bar. Then adhere i-PVDF extruded thin film on top of the sealing coating. If the i-PVDF film can be easily peeled and removed by hand, the coating is not adhering sufficiently and will not create a waterproof seal.

Sample preparation: Fluoropolymer was dissolved into solvent at preferred solid content to reach desired viscosity profile. If the fluoropolymer did not fully dissolved at room temperature, elevated temperature of between 40° C. and 60° C. was used to help dissolve the fluoropolymer. Elevated temperature can be reached either by oven or by water bath. After the fluoropolymer was fully dissolved, a brush or tongue presser was used to apply the solution onto the round cable while rotating the cable.

The example compositions were applied to a PVDF insulated covered copper cable having an open region (no PVDF insulating covering in the open region). The example compositions were applied to the open region and the portions of the PVDF insulating covering contiguous with the open region.

Sample drying: The adhesive coating were dried either at room temperature or at elevated temperature with different solvent packages. For the elevated temperature drying, a heat gun was utilized. The drying time at elevated temperature ranges from 2 min to 5 min. Usually, the higher the elevated temperature, the less the drying time.

### Materials

PVDF A is a polyvinylidene fluoride-hexafluoropropylene (PVDF-HFP) copolymer having about 17 wt. % HFP in the polymer. PVDF A has a weight average molecular weight is about 205 kg/mol and the polydispersity index is 1.95. The melt viscosity is 8 kP at 100 s⁻¹@230° C.

PVDF B is a polyvinylidenefluoride-hexafluoropropylene (PVDF-HFP) copolymer. The weight percent of the HFP part in the PVDF-HFP copolymer is around 17 wt. % in total polymer. The weight average molecular weight is 133 kg/mol and the polydispersity index is 1.72. The melt viscosity is 1 kP at 100 s⁻¹@230° C.

PVDF C is a polyvinylidene fluoride-hexafluoropropylene (PVDF-HFP) copolymer. The mass percent of the HFP part in the PVDF-HFP copolymer is around 18 wt. % in total polymer. The melt viscosity is 13 kP at 100 s⁻¹@230° C.

PVDF D is an acrylic modified fluoropolymer composition where polyvinylidene fluoride-hexafluoropropylene (PVDF-HFP) was used as seed. Solids content of this latex is around 44 wt. %. The weight percent of the HFP part in the PVDF-HFP copolymer is around 20 to 22 wt. % and the acrylic part is around 30 wt. % in total polymer. The acrylic part has a glass transition temperature of 46° C.

TABLE 1

| | | Melt Viscosity |
|---|---|---|
| | Molecular Wt. | (kP @ 100 s⁻¹ |
| Example | (kg/mol) | @230° C.) |
| PVDF A | 205 | 8 |
| PVDF B | 133 | 1 |
| PVDF C | — | 13 |
| PVDF D | — | 14 |

### Example 1: (PVDF A in Cyclopentanone)

PVDF A powder was dissolved at 30 wt. % into the cyclopentanone.

The solution from example 1 is applied to a copper cable comprised of a PVDF primary insulation and having an open region with no PVDF insulating covering, and then dried at 150° C. (302ºF) with a heat gun for 4 minutes, or dried at 60° C. for 2 hrs. In both cases a homogenous sealing coating without bubbles was formed.

### Example 2: (PVDF A in Cyclopentanone and Acetone for Field Applied/Room Temperature Application)

PVDF A powder was dissolved at 30 wt. % into the mixture of cyclopentanone and acetone. The mix ratio of cyclopentanone and acetone is 1:1 by weight. The solution from example 2 was applied to a copper cable comprised of a PVDF primary insulation and having an open region with no PVDF insulating covering, and then dried at room temperature for at least 10 minutes. A homogenous sealing coating without bubbles was formed.

### Comparative Example 1: (PVDF B in Cyclopentanone)

PVDF B powder was dissolved at 30 wt. % into the cyclopentanone. The solution from comparative example 1 was applied to a copper cable comprised of a PVDF primary insulation and having an open region with no PVDF insulating covering, and then dried at 60° C. for 2 hrs. The coating was easily peeled and removed by hand.

### Comparative Example 2: (PVDF C in Cyclopentanone)

PVDF C powder was dissolved at 30 wt. % into the cyclopentanone. The solution from comparative example 2 was applied to a copper cable comprised of a PVDF primary insulation and having an open region with no PVDF insulating covering, and then dried at 60° C. for 2 hrs. The coating was easily peeled and removed by hand.

### Comparative Example 3: (PVDF D in Cyclopentanone)

The fluoropolymer-acrylic composition was dissolved in solvent of cyclopentanone and the solution concentration was 30 wt %. by mass. The solution from comparative example 3 was applied to a copper cable comprised of a PVDF primary insulation and having an open region with no PVDF insulating covering, and then dried at 60° C. for 2 hrs. The coating was easily peeled and removed by hand.

### Comparative Example 4: (PVDF A in Cyclopentanone and Acetone Dried at Elevated Temperature)

A polyvinylidene fluoride-hexafluoropropylene (PVDF-HFP) copolymer powder was dissolved at 30 wt. % into the mixture of cyclopentanone and acetone. The mix ratio of cyclopentanone and acetone was 1:1 by weight. The solution from comparative example 4 was applied to a copper cable comprised of a PVDF primary insulation and having an open region with no PVDF insulating covering, and then dried at elevated temperature by a heat gun. The elevated temperature range is 175° C. to 204° C. and the drying time was 2 min to 4 min. An adhesive coating with many bubbles was formed.

Without wishing to be bound by theory is it theorized that Comparative example 4 failed because the elevated temperature dried the sealing coating too fast resulting in poor adhesion and creation of pockets in the coating.

### Comparative Example 5: (PVDF A in Acetone)

A PVDF A powder was dissolved at 30 wt. % into acetone. The solution from comparative example 5 was applied to a copper cable comprised of PVDF primary having an open region with no PVDF insulating covering, and then dried at room temperature. A discontinuous film was formed and cannot provide a continuous sealing connecting coating.

TABLE 2

| | | | | Pass/ |
|---|---|---|---|---|
| Example | PVDF | Solvent | Drying condition | Fail |
| 1-a | PVDF A | cyclopentanone | 150° C. for 4 min | Pass |
| 1-b | PVDF A | cyclopentanone | 60° C. for 2 hrs | Pass |
| 2 | PVDF A | Cyclopentanone | Room Temp. | Pass |
| | | and acetone 1:1 | | |
| Comp 1 | PVDF B | cyclopentanone | 60° C. for 2 hrs | Fail |
| Comp 2 | PVDF C | cyclopentanone | 60° C. for 2 hrs | Fail |
| Comp 3 | PVDF D | cyclopentanone | 60° C. for 2 hrs | Fail |
| Comp 4 | PVDF A | cyclopentanone | 175-204° C. | Fail |
| | | and acetone 1:1 | for 2 min | |
| Comp 5 | PVDF A | Acetone | Room temp | Fail |

1. A connecting composition comprising a PVDF copolymer and a solvent, wherein the solvent comprises cyclic ketone, wherein the weight percent of PVDF copolymer is from 20 to 40 wt. % based on the total weight of PVDF copolymer and solvent, wherein the PVDF copolymer comprises one or more comonomers and at least 75 wt. % vinylidene fluoride units, and has a melt viscosity of 2 to 12 kPoise at 230° C. and 100 s⁻¹.

2. The composition of claim 1, wherein the PVDF copolymer comprises from 2 to 25 wt. % co-monomer.

3. The composition of claim 1, wherein the co-monomer is selected from the group consisting of vinyl fluoride; trifluoroethylene (VF3); chlorotrifluoroethylene (CTFE); 1,2-difluoroethylene; tetrafluoroethylene (TFE); hexafluoropropylene (HFP); 2,3,3,3-tetrafluoropropylene; 1,3,3,3-tetrafluoropropylene; 3,3,3-trifluoropropylene; perfluoro(alkyl vinyl) ethers; perfluoro(1,3-dioxole); perfluoro(2,2-dimethyl-1,3-dioxole) (PDD), and combinations thereof.

4. The composition of claim 1, wherein the co-monomer comprises HFP.

5. The composition of claim 1, wherein the cyclic ketone comprises cyclopentanone.

6. The composition of claim 1, wherein the solvent further comprises a co-solvent.

7. The composition of claim 6, wherein the co-solvent comprises acetone or a C1 to C6 alcohol.

8. The composition of claim 1, wherein the cyclic ketone comprises greater than 20 wt. % of the total solvent.

9. A method of coating a cable or wire joint, the method comprising providing the connecting composition of claim 1, providing a joint connecting a first cable or wire or sensor to a second cable or wire wherein at least one of the first cable or wire or sensor or the second cable or wire has an fluoropolymer insulation thereon except at an open region where the first cable or wire or sensor is connected to the second cable or wire, applying the connecting composition about the joint to completely cover the joint and bond to portions of the insulating covering contiguous with the open region to provide a continuous fluoropolymer insulating covering the joint.

10. A method of repairing a break in wire or cable fluoropolymer insulation comprising providing the connecting composition of claim 1, providing a wire or cable having a break in the fluoropolymer insulation of the wire or cable, applying the connecting composition over the break in the insulation, drying the applied connecting composition to create a continuous fluoropolymer insulating covering on the break.

11. The method of claim 9, wherein the connecting composition is applied by spraying or painting the connecting composition onto the cable or wire.

12. The method of claim 9, wherein the connecting composition is applied at ambient temperature.

13. The method of claim 9, wherein the connecting composition is dried at a temperature of from 20° C. up to a temperature of 160° C.

14. The method of claim 9, wherein the heat is applied locally to the connecting composition covering the open region or insulation break.

15. The method of claim 9, wherein the method further comprising applying more than one layer of the connecting composition.

16. The method of claim 9, wherein the fluoropolymer insulation comprises a homopolymer or copolymer having a melt viscosity of from 4 to 40 kP measured at 100 sec⁻¹ at 230° C.

17. The method of claim 16, wherein the wherein the fluoropolymer insulation comprises a polyvinylidene fluoride homopolymer or copolymer.

18. A joint connecting a first cable or wire or sensor to a second cable or wire, wherein at least one of the cables or wires comprises a fluoropolymer insulation, wherein said joint additionally comprises a sealing coating covering the joint and bonded to portions of the fluoropolymer insulation contiguous with the joint to thereby insulate the joint, wherein the sealing coating comprises a PVDF copolymer having a melt viscosity of 2 to 12 kPoise at 230° C. and 100 s⁻¹.

19. The joint of claim 18, wherein the PVDF copolymer comprises from 2 to 25 wt. % co-monomer.

20. The composition of claim 19, wherein the co-monomer is selected from the group consisting of vinyl fluoride; trifluoroethylene (VF3); chlorotrifluoroethylene (CTFE); 1,2-difluoroethylene; tetrafluoroethylene (TFE); hexafluoropropylene (HFP); 2,3,3,3-tetrafluoropropylene; 1,3,3,3-tetrafluoropropylene; 3,3,3-trifluoropropylene; perfluoro(alkyl vinyl) ethers; perfluoro(1,3-dioxole); perfluoro(2,2-dimethyl-1,3-dioxole) (PDD), and combinations thereof.

21. The composition of claim 19, wherein the co-monomer comprises HFP.

22. The joint of claim 18, wherein the fluoropolymer insulation is a PVDF homopolymer or copolymer.

23. The joint of claim 18, wherein the sealing connecting composition adheres to the fluoropolymer insulation and forms a water proof seal.

24. The joint of claim 18, wherein one layer of the sealing coating is from 60 to 200 micron thick.
